(19) United States
(12) Patent Application Publication
(10) Pub. No.: US 2007/0271829 A1
(43) Pub. Date: Nov. 29, 2007

(54) Reminder kit

(76) Inventor: Gary M. Knight, Corona, CA (US)

Correspondence Address: Harold L. Jackson;Jackson Law Corporation, Ste. N, 14751 Plaza Dr., Tustin, CA, 92780, US

(21) Appl. No.: 11/440,258

(22) Filed: May 24, 2006

(51) Int. Cl. G09F 3/20

(52) U.S. Cl. 40/654.01

(57) ABSTRACT

A reminder kit and method is disclosed having a pocket portion with an opening for receiving cards. The cards are used to write notes such as class homework assignments by subject. The pocket portion may be attached to a bag such as a backpack or purse for transport. The cards may be rewritable for reusing the cards as needed on subsequent occasions. The cards may be made of plastic which allows notes to be written or erased by an erasable marker. A sleeve added to the pocket portion can carry the marker or other writing implement.

### FIELD OF THE INVENTION

This invention relates generally to task reminder devices and methods and more particularly to a system for reminding people of daily assignments and tasks. The invention is applicable for use by students to remind them of daily homework assignments.

### BACKGROUND OF THE INVENTION

Every day people are taking on responsibilities and tasks that need to be completed for work, school, home and other places. Whether the tasks relate to simple household chores, homework assignments or work tasks, remembering the myriad of “things to do” can be challenging. Such daily requirements furthermore fall on everyone in society, including children, students and adults alike. A variety of visual devices and methods have been developed for the purpose of reminding one to complete their tasks. Writing a list on a piece of paper is probably the most common manual method of recording tasks, with an electronic memo pad such as a PDA or computer calendaring system representing the most complex.

In another example, U.S. Pat. No. 6,837,714 to Womack discloses a reminder board made of magnetic sheet material that may be placed on a metal surface such a refrigerator. Smaller pieces of the same material have chores or duties written on them. The smaller pieces are placed under a heading of “Please do” and then moved to an area that says “Thank You” as the chore is completed. U.S. Pat. No. 3,290,796 to Gurda discloses another board reminder apparatus with a coin reward dispenser for completed tasks. Published Patent Application No. 2004/0089562 A1 discloses a compact case for holding repositionable notes including a plastic case with an integrally hinged lid. The compact case allows the repositionable note paper and other items to be carried in a shirt pocket, wallet or the like without flexural damage or soiling. U.S. Pat. No. 4,976,622 to Clark discloses a two panel folder, each panel having a set of pockets with a number of tickets or cards with meals or medications written on them. This reminder system assists a patient with diabetes to plan meals with different foods allowed and to meet a medication schedule. U.S. Pat. No. 5,097,961 to Patino et al. discloses a calendar display board with a number slots that are assigned a number indicating a particular day of the month. Envelopes with bills monthly bills to be paid are placed in a slot corresponding to the date on which the bill is to be paid. U.S. Pat. No. 6,678,974 to Su discloses a card file device having a base board, jacket, envelopment and plurality of envelopes. This card file device can be folded or extended for display purposes. U.S. Pat. No. 5,797,204 to Paulo discloses a calendar organizer having pockets representing the days of the month, the pockets receiving documents or tasks that need to be completed.

These described reminder devices are for the most are large and bulky. There remains a need for a reminder device and methodology that is easily transportable. It would also be advantageous to have portable reminder device that is reusable.

### SUMMARY OF THE INVENTION

The invention broadly provides a reminder system including a pouch with a pocket and one or more cards that are sized to be inserted into the pocket of the pouch. The card has a place to write notes thereon, such as tasks or assignments, for example Furthermore, one or more of the cards may have pre-printed subject matters. Lines may also be pre-printed on the cards. Also, as an additional feature, the cards may be made of material which facilitates the writing of erasable notes such as by a pencil or erasable marker. In a preferred embodiment the card material may be plastic.

Other additional features may be added to the pouch. The pouch may include a sleeve for holding a writing implement such as a pen, pencil, erasable marker or the like. Also, the pouch may include a mechanism for attaching the pouch to another object for transport, such object which may be a backpack or a purse. For example, a clip may be attached to the pocket. As another alternative, Velcro may also be used.

The construction and use of preferred embodiments of a reminder device and method may best be understood by reference to the following description taken in conjunction with the accompanying drawings.

### BRIEF DESCRIPTION OF DRAWINGS

FIG. 1 is a front view of the pocket portion of the reminder kit in accordance with the principles of the invention;

FIG. 2 is a back view of the reminder kit;

FIG. 3 illustrates a number of possible cards or tags for the reminder kit;

FIG. 4 is a front view of the pocket portion of the reminder kit with a card inserted;

FIG. 5 is an is a front view of an alternative embodiment of the pocket portion including a clip;

FIG. 6 is a back view of the pocket portion of the reminder kit with a Velcro patch affixed thereto;

FIG. 7 is a front view of the pocket portion of FIG. 5 with a sleeve for holding a writing implement;

FIG. 8 is a front view of the pocket portion of FIG. 7 with a writing implement inserted into the sleeve and two note cards inserted in the pocket portion;

FIG. 9a is a front view of a card being written with notes;

FIG. 9b is a front view of the pocket portion with card being inserted or withdrawn from the pocket portion, and

FIG. 9c is a front view of a card with the notes being erased.

### DESCRIPTION OF PREFERRED EMBODIMENTS

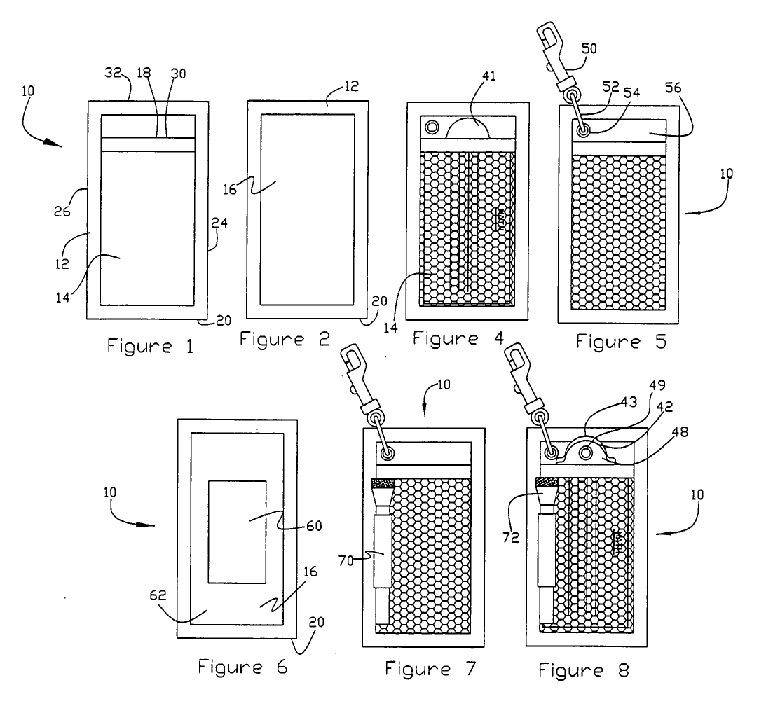

Referring now to the drawings and more particularly to FIGS. 1 and 2, there is shown a preferred embodiment of the reminder kit 10 in accordance with the principles of the invention including a pocket portion 12 with front panel 14 and back panel 16 with an opening 18. While the pocket portion 12 may be of a variety of shapes and sizes, the front panel 14 and back panel 16 are shown in this embodiment as rectangularly shaped forming a bottom edge 20, side edges 24 and 26. The top edges 30 and 32 of the front panel 14 and back panel 16 are preferably spaced apart making notes cards (to be described below) more accessible to grasp by the fingers of a hand for insertion and removal. The front panel 14 and back panel 16 may be made of any materials, such as synthetic fabric materials. In this example shown in FIGS. 1 and 2, the back panel 16 is a solid flexible planar material (see FIG. 2) while the front panel 14 may a similar be a similar solid flexible planar material as shown in FIG. 1. Alternatively, the front panel 14 maybe a mesh material as shown in FIG. 4, for example.

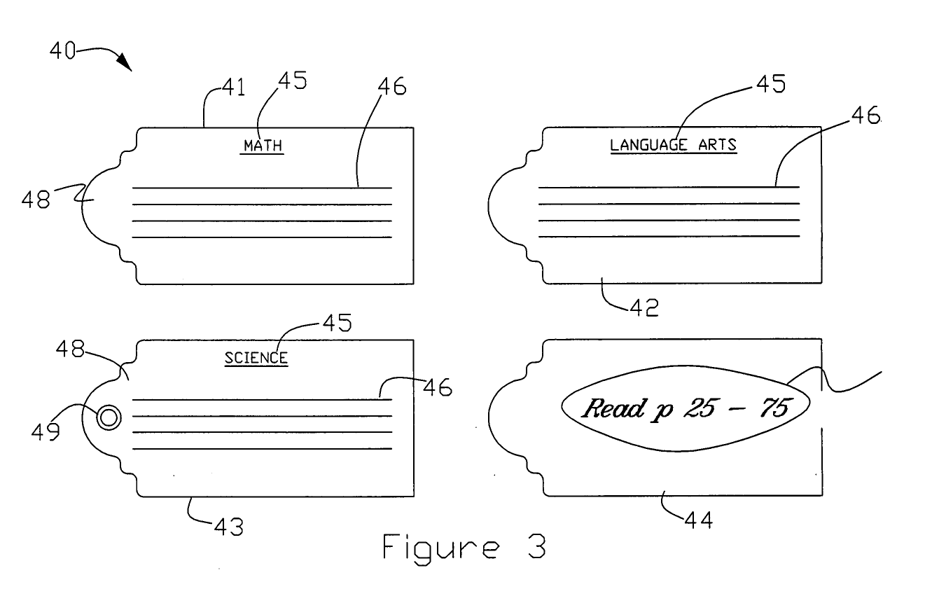

The reminder kit 10 includes one or more cards 40 as shown with more particularity in FIG. 3. Four cards 41, 42, 43 and 44 are illustrated in this example. The cards 40 may have subjects 45 pre-printed thereon, such as class subjects which on card 41 is “MATH”, card 42 “LANGUAGE ARTS” and card 43 “SCIENCE”. The cards 40 may also have pre-printed lines 46 making it easier to writes notes on the cards. Cards 40 may also be blank as illustrated by card 44, on which any subject matter or notes or other written matter can be transcribed thereon as desired by the user. Notes or other written material can also be attached to cards 40 such as by repositionable notes such as Post-it® notes available from the 3M Company, for example.

The cards 40 themselves may be made of any material suitable for recording written notes or symbols. A pen, pencil, marker or other writing implement may be used as the note writing medium for the cards. Preferably, the cards 40 may be made of plastic material suitable for using an erasable marker or grease type pencil. Accordingly, notes can be written on a card and later wiped off or erased from the card and other material then written or drawn onto the card. The material for the cards may also be chosen to be a stiff material which facilitates making notes in various environments or conditions. While the cards maybe of any size and shape, cards 40 are rectangularly shaped to fit in the rectangularly shaped pocket portion 12 described above. One end 48 of the cards 40 may have a hole 49. Card 41 is shown inserted into pocket portion 12 in FIG. 4. With the spaced top edges 30 and 32 of the front and back panels, the end of the card 41 will stick out from and above front panel 14 of the front pocket portion 12, making it easier to grasp, which facilitates insertion and removal.

The pocket portion 12 may also be attached to a variety of items such as a backpack or purse, for example, by a variety of means. Simple attachment mechanisms include common items such as pins, bobby pins, clips for example. In FIG. 5 a clip 50 is attached by a ring 52 to a hole 54 in the top portion 56 of the back panel 16 of pocket portion 12. The clip may readily be attached to other items such as a D-ring or strap of a backpack or purse, or even a belt loop in a pair of pants, for example (not shown). Another attachment mechanism as shown in FIG. 6, could be a patch of Velcro 60 which is affixed to the back surface 62 of back panel 16. A corresponding mating patch of Velcro is affixed to another item such as a backpack or purse. The pouch can easily be attached and separated as desired by means of the Velcro.

In FIG. 7, a sleeve 70 is added to the front panel 14 of the pocket portion 12. The sleeve is sized and shaped to receive a writing implement 72 such as a pencil, pen, marker, erasable marker or grease pencil, for example. The sleeve 70 may be made of any suitable material, but preferably is made of an elastic material formed into a cylindrical shape which resiliently holds a writing implement facilitating transport thereof. A preferred embodiment including the sleeve 70 and clip 50 with two note cards 40, namely cards 42 and 43 inserted is illustrated in FIG. 8. Grasping the front card 42 with the hole 49 by the end 48 of card, the card 42 can be removed for note taking, viewing or erasing and re-writing. This reminder kit 10 is advantageously very transportable and simple to use. Everything desired for reminder note taking is carried with the kit.

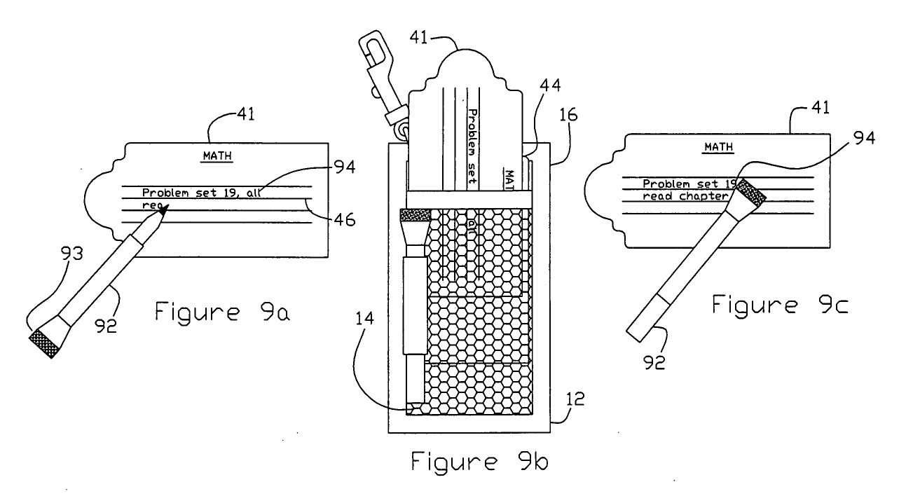

In FIGS. 9a-c there is shown a front view of the reminder kit 40 illustrating its methodology in use. In FIG. 9a, the user by means of his hand and fingers (not shown) using a selected writing implement 92, writes notes 94 on one of the cards 41, for example. In this example, the card 41 with the pre-printed subject “MATH” thereon has notes added stating “problems 19, all” on one of the lines (46) and “read Chapter 10” on a second line. While a card with pre-printing subjects and lines may be preferred for known subjects, blank cards such as card 44 may also be use. Card 41 is then hand inserted into the opening 18 of the pocket portion 12, as shown in FIG. 9b. One or more cards 40 may be employed, card 44 shown already seated in the pocket portion. Card 41 or 44 may likewise be removed from the pocket 12 by hand for writing, viewing or other reasons. In FIG. 9c, the eraser portion 93 of writing implement 92 is shown erasing the written notes 94 described above. This simple reminder methodology makes the reminder kit desirable for use by people of all ages.

There has thus been described a reminder kit and method that is flexible and can be applied to a variety of situations. Various modifications to the reminder kit and its method will occur to persons skilled in the art without involving any departure from the spirit and scope of the invention set forth in the appended claims.

What is claimed is:

1. A reminder system, comprising:
a pouch with a pocket; and
at least one card sized to be inserted into the pocket of the pouch, the at least one card having pre-printed subjects thereon with an area to write notes thereon.

2. The reminder system of claim 2 wherein the at least one card comprises a plurality of cards, the cards having pre-printed subjects thereon with space for writing notes relating to the subjects.

3. The reminder system of claim 2 wherein the cards are made of plastic material such that written notes can be written and erased by means of an erasable writing implement.

4. The reminder system of claim 1 wherein the pouch includes a sleeve to receive a writing implement.

5. The reminder system of claim 4 further includes a writing implement insertable into the sleeve.

6. The reminder system of claim 5 wherein the at least one card is blank.

7. The reminder system of claim 1 wherein the pocket has a back surface with a Velcro patch for attaching to another cooperative Velcro patch.

8. The reminder system of claim 1 wherein the pouch has a clip attached thereto for attaching the pouch to another object for transport.

9. A reminder kit, comprising:
a plurality of tags;
a tag holder having a planar back panel and a planar front panel cooperatively forming a pocket therebetween with an opening for receiving the tags; and
an attachment mechanism wherein the tag holder can be releasable attached to another object.

10. The reminder kit of claim 9 wherein the back and front panels have horizontal edges, the front panel horizontal edge being spaced from the back panel horizontal edge such that the tags when inserted into the pocket extend out from the front panel horizontal edge.

11. The reminder kit of claim 10 wherein the tags are substantially rectangularly shaped.

12. The reminder kit of claim 11 wherein the tags have pre-printed subjects thereon.

13. The reminder kit of claim 9 wherein the attachment mechanism is a Velcro patch attached to the planar back panel.

14. The reminder kit of claim 9 wherein the attaching mechanism is a clip secured to the planar back panel.

15. The reminder kit of claim 9 wherein the tag holder includes a means for securing a writing implement thereto.

16. The reminder kit of claim 9 wherein the tags are made of hard plastic.

17. The reminder kit of claim 16 further including an erasable writing implement insertable into the writing implement securing means.

18. A personal reminder method, comprising the steps of:
providing one or more tags, one or more of the tags being directed to a study subject,
providing a pocket for holding the tags;
writing assignment notes on one or more of the tags relating to the subjects; and
placing one or more of the tags in the pocket.

19. The personal reminder method of claim 17, further comprising the steps of:
erasing the assignment notes on one or more of the tags.

20. The personal reminder method of claim 18, further comprising the steps of:
writing other assignment notes on one or more of the tags.
